(19) United States
(12) Patent Application Publication
(10) Pub. No.: US 2009/0018681 A1
(43) Pub. Date: Jan. 15, 2009

(54) APPARATUS AND METHOD OF CONTROLLING REPRODUCTION OF MEDIA SIGNAL USING TAG

(75) Inventors: Jae-cheol LEE, Hwaseong-si (KR); Byung-soo Kim, Seoul (KR); Hee-soo Lee, Suwon-si (KR); Yong-jun Park, Seoul (KR)

Correspondence Address: STANZIONE & KIM, LLP, 919 18TH STREET, N.W., SUITE 440, WASHINGTON, DC, 20006, US

(73) Assignee: Samsung Elecatronics Co., Ltd., Suwon-si (KR)

(21) Appl. No.: 12/045,127

(22) Filed: Mar. 10, 2008

(30) Foreign Application Priority Data
Jul. 10, 2007 (KR) 2007-69214

(51) Int. Cl. G06F 17/00

(52) U.S. Cl. 700/94

(57) ABSTRACT

A method and apparatus to control reproduction of a media signal by using a tag includes receiving a request for generating tag information for controlling the reproduction of the media signal using a tag, generating the tag information according to the request for generating tag information, and storing the generated tag information in a tag. The tag information is generated independently from an original media signal and is used in controlling the media signal, and thus the reproduction of the media signal can be controlled without editing the media signal.

### CROSS-REFERENCE TO RELATED APPLICATIONS

This application claims the benefit under 35 U.S.C. §119(a) from Korean Patent Application No. 10-2007-0069214, filed on Jul. 10, 2007, in the Korean Intellectual Property Office, the disclosure of which is incorporated herein in its entirety by reference.

### BACKGROUND OF THE INVENTION

1. Field of the Invention

The present general inventive concept relates to controlling reproduction of a media signal, and more particularly, to a method of controlling reproduction of a media signal and an apparatus to control reproduction of a media signal using tag.

2. Description of the Related Art

Since digital technologies have been developed, various apparatus for controlling reproduction of a media signal of a device (e.g., digital televisions (TVs), computers, cellular phones, MP3 players, portable multimedia players (PMPs) or the like) have become widely popular. An apparatus for controlling reproduction of a media signal can reproduce a media signal transmitted from other devices through a network, reproduce broadcasting information received by a broadcasting receiver, or extract a media signal stored in an inner or outer storage medium to reproduce the media signal. A user can use a media signal that is originally reproduced and edit the media signal to reproduce the media signal according to a user preference. However, in order to edit a media signal a user must go through the inconvenience of re-editing a decoded media signal and then encode the result of re-editing the signal. When the media signal is encoded, a time taken to edit the signal is required, a corresponding method is complicated, and various encoding apparatuses are required according to the kind of a media signal file. In addition, when an original media signal is edited, the original media signal cannot be restored. When an original file is maintained, and a media signal is edited and stored as a new file, a storage space is wasted due to double storage of a media signal.

When a media signal is reproduced, a user can reproduce a media signal in various ways, for example, by skipping a predetermined section of the media signal or by regulating a reproducing speed of a predetermined section. The user can achieve the same effect as editing the media signal by changing a method of reproducing the media signal. However, whenever a media signal is reproduced, it is inconvenient for a user to regulate a reproducing method. In addition, it is difficult to reproduce a media signal repeatedly by using the same reproducing method.

### SUMMARY OF THE INVENTION

The present general inventive concept provides a method and apparatus to control reproduction of a media signal without an encoding device.

The present general inventive concept also provides a method and apparatus to control reproduction of a media signal without damaging an original media signal.

The present general inventive concept also provides a method and apparatus to control reproduction of a media signal by using a tag, wherein tag information is generated so as to be stored in order to control the media signal, and thus a space for controlling the reproduction of the media signal is small, and the same method of controlling a media signal can be repeatedly used.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by proving a method of controlling reproduction of a media signal using a tag, the method including receiving a request for generating tag information for controlling the reproduction of the media signal, generating the tag information according to the request for generating tag information, and storing the generated tag information in a tag.

The receiving of the request for generating tag information may include receiving one of a request for starting control and a request for finishing control, and a controlling property selected by a user.

The generating of the tag information may include, according to the request for starting control or the request for finishing control, extracting a reproducing time of the media signal of a point at which the request for starting control or the request for finishing control is received; and generating an identifier indicating one of the request for starting control and the request for finishing control, and the storing of the generated tag information may include storing an identifier indicating one of the request for starting control and the request for finishing control, and the extracted reproducing time of the media signal and the controlling property in the tag.

The generating of the tag information may include generating the tag information for each respective reproducing time of the media signal, according to an order of request for generating tag information.

The receiving of the requesting for generating the tag information may include receiving the request for finishing control included in the tag information of which a tag property is the same as a tag property of tag information included in the request for starting control, after receiving the request for starting control.

The foregoing and/or other aspects and utilities of the present general inventive concept may also be achieved by proving a method of controlling reproduction of a media signal, the method including receiving a selection of tag information that is to be used for controlling reproduction of the media signal; and controlling the reproduction of the media signal by using the selected tag information, wherein the controlling of the reproduction comprises: extracting the tag information that is stored independently from the media signal so as to generate the media signal according to the tag information.

The tag information may include an identifier indicating one of a request for starting control and a request for finishing control, and a reproducing time of reproduction of the media signal of a point, at which the request for starting control or the request for finishing control is received, according to the request for starting control or the request for finishing control, and a controlling property, and the controlling of the reproduction of media signal may include, when the reproducing time of the media signal which is currently being reproduced is the same as the reproducing time of media signal which is stored according to the request for starting control, reproducing the media signal according to the controlling property included in the tag; and when the reproducing time of the media signal is the same as the reproducing time of the media signal which is stored according to the request for finishing control, finishing the reproduction of the media signal according to the controlling property included in the tag.

The receiving of the selection of tag information may be performed by using the controlling property included in the tag information, and the controlling of the reproducing of the media signal may include extracting all tags including the selected controlling property; and controlling the reproduction of the media signal according to the controlling property, using an identifier indicating one of the request for starting control and the request for finishing control, and a reproducing time of the media signal, which is stored according to the request for starting control and the request for finishing control, which are include in the extracted tag.

A number of pieces of the tag information including the same controlling property may be two or more.

The receiving of the selection of the tag information may include receiving a selection of a plurality of controlling properties, and wherein the extracting of the all tags including the selected controlling property comprises: extracting all tags including the selected controlling properties.

The foregoing and/or other aspects and utilities of the present general inventive concept may also be achieved by proving an apparatus for controlling reproduction of a media signal using a tag, the apparatus including a decoding unit to decode an input media signal, a media signal output unit to output the decoded media signal, a tag information processing unit to generate tag information to control the reproduction of the media signal, and to store the generated tag information, a user interface, and a controlling unit to control reproduction of the media signal, and generating the tag information according to a request of a user using the user interface and storing the generated tag information.

The tag information processing unit may include a tag information generating unit to generate the tag information according to the request of the user; and a tag information storage unit in which the generated tag information is stored.

The apparatus may further include an on screen display (OSD) processing unit to generate OSD data including a list for generating tag information and outputting the OSD data, in order to receive the request for generating tag information from a user.

The controlling unit may receive one of a request for starting control and a request for finishing control, and a controlling property from the user, and may transmit one of the request for starting control and the request for finishing control, and the controlling property to the tag information generating unit to request generation of tag information, according to the request for starting control or the request for finishing control, the tag information generating unit may a reproducing time of the media signal when the request for starting control or the request for finishing control is made, and may generate an identifier indicating one of the request for starting control and the request for finishing control, and the tag information storage unit may the identifier indicating one of the request for starting control and the request for finishing control, the extracted reproducing time of the media signal and the controlling property in the tag.

The tag information generating unit may generate the tag information for each respective reproducing time of the media signal according to an order of request for generating the tag information.

The controlling unit may receive the request for finishing control included in tag information having the same property as the tag information in which the request for starting control is included, after the request for starting control is received from the user.

The foregoing and/or other aspects and utilities of the present general inventive concept may also be achieved by proving an apparatus to control reproduction of a media signal using a tag, the apparatus including a decoding unit to decode an input media signal, a media signal outputting unit to output the decoded media signal, a tag information processing unit to compare tag information with the media signal in order to control the reproduction of the media signal, a user interface, and a controlling unit to control reproduction of the media signal, to receive selection of the tag information, which is to be used in reproduction of the media signal, from a user, and to control the reproduction of the media signal according to the selected tag information.

The apparatus may further include an on screen display (OSD) processing unit to generate OSD data including a list for selecting tag information, and to output the OSD data in order to receive selection of tag information from the user.

The tag information may include an identifier indicating one of a request for starting control and a request for finishing control, a reproducing time of the media signal when the request for starting control or the request for finishing control is made, and a controlling property, and when a reproducing time of the media signal which is currently being reproduced is the same as the reproducing time of a media signal stored according to the request for starting control, the controlling unit may reproduce the media signal according to the controlling property included in the tag, and when the reproducing time of the media signal is the same as the reproducing time of the media signal stored according to the request for finishing control, the controlling unit may finish the reproduction of the media signal according to the controlling property.

The controlling unit may receive selection of tag information using the controlling property included in the tag information from the user, extract all tag including the selected controlling property, and control the reproduction of the media signal according to the controlling property, using the identifier included in the extracted tag, indicating one of the request for starting control and the request for finishing control, the reproducing time of the media signal, included in the extracted tag, which is stored according to the request for starting control or the request for finishing control.

The tag information may include at least two pieces of tag information including the same controlling property.

When selection of a plurality of controlling properties may be received from the user, the controlling unit may extract all tags including the controlling properties.

The foregoing and/or other aspects and utilities of the present general inventive concept may also be achieved by proving an apparatus to control reproduction of a media signal using a tag, the apparatus including a media signal reproducing unit to decode a media signal and to output the decoded media signal, and a media signal reproduction controlling unit to receive a request for generating tag information to control reproduction of a media signal, to generate the tag information according to the request for generating tag information, and to store the generated tag information in a tag corresponding to the media signals.

The foregoing and/or other aspects and utilities of the present general inventive concept may also be achieved by proving an apparatus to control reproduction of a media signal using a tag, the apparatus including a media signal reproducing unit to decode a media signal and to output the decoded media signal, and a media signal reproduction controlling unit to receive a selection of the tag information that is to be used to control reproduction of the media signal, to control the reproduction of the media signal by using the selected tag information by extracting the tag information that is stored independently from the media signal so as to generate the media signal according to the tag information.

The foregoing and/or other aspects and utilities of the present general inventive concept may also be achieved by proving an apparatus to control reproduction of a media signal using a tag, the apparatus including a media signal reproducing unit to decode a media signal and to output the decoded media signal, and a media signal reproduction controlling unit to receive a request for generating tag information to control reproduction of a media signal, to generate the tag information according to the request for generating tag information, to store the generated tag information in a tag corresponding to the media signals, to receive a selection of the tag information that is to be used to control reproduction of the media signal, to control the reproduction of the media signal by using the selected tag information by extracting the tag information that is stored independently from the media signal so as to generate the media signal according to the tag information.

The foregoing and/or other aspects and utilities of the present general inventive concept may also be achieved by proving a method of controlling reproduction of a media signal using a tag, the method including receiving a request for generating tag information to control reproduction of a media signal, generating the tag information according to the request for generating tag information, and storing the generated tag information in a tag corresponding to the media signal, and receiving a selection of tag information that is to be used to control reproduction of the media signal, and controlling the reproduction of the media signal by using the selected tag information by extracting the tag information that is stored independently from the media signal so as to generate the media signal according to the tag information.

The foregoing and/or other aspects and utilities of the present general inventive concept may also be achieved by providing an apparatus to control reproduction of a media signal using a tag, the apparatus including a media signal reproducing unit to decode a media signal and output the decode media signal, and a media signal reproduction controlling unit to independently process tag information from the media signal reproducing unit, and to control the media signal reproducing unit to decode and output the media signal according to the tag information.

The media signal reproducing unit does not encode the media signal and the tag information.

The tag information may include a reproducing time and a reproducing property corresponding to the reproducing time, the media signal reproducing unit may generate a current reproducing time and a current reproducing property of the media signal, and the media signal reproduction controlling unit may control the media signal reproducing unit to decode and output the media signal according to the reproducing time and the reproducing property of the tag information and the current reproducing time and the current reproducing property of the media signal.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an apparatus to control reproduction of media signal, according to an embodiment of the present general inventive concept;

FIG. 2 is a view illustrating a media signal in a time sequence, according to an embodiment of the present general inventive concept;

FIGS. 3 and 4 are views illustrating a media signal reproduced when the media signal is controlled to be reproduced using tag information generated in FIG. 2, according to embodiments of the present general inventive concept;

FIG. 5 is a view illustrating tag information generated according to an embodiment of the present general inventive concept;

FIG. 6 is a view illustrating an on screen display (OSD) output screen, according to an embodiment of the present general inventive concept;

FIG. 7 is a flow chart illustrating a method, in which tag information is input by a user in order to perform a method of controlling reproduction of a media signal, according to an embodiment of the present general inventive concept;

FIG. 8 is a flow chart illustrating a method of generating tag information, which is performed in an apparatus to control reproduction of a media signal, according to an embodiment of the present general inventive concept; and

FIG. 9 is a flow chart illustrating a method of control reproduction of a media signal, which is performed in an apparatus to control reproduction of a media signal, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

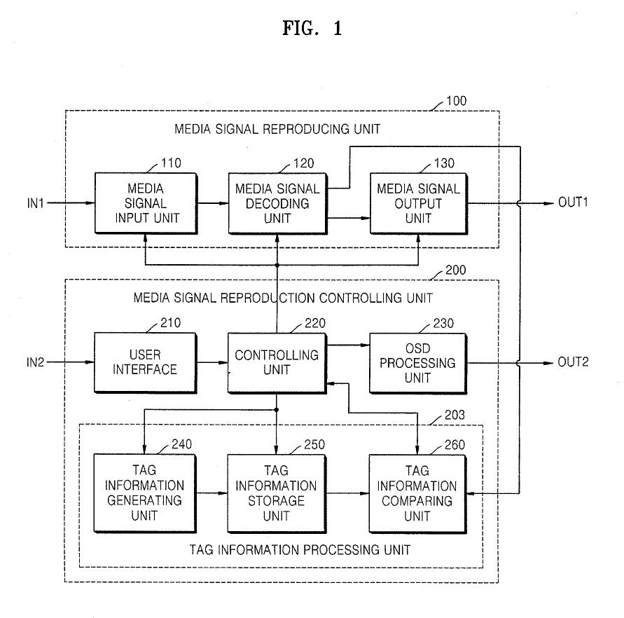

FIG. 1 is a block diagram illustrating an apparatus to control reproduction of a media signal, according to an embodiment of the present general inventive concept. Referring to FIG. 1, the apparatus includes a media signal reproducing unit 100 and a media signal reproduction controlling unit 200. The media signal reproducing unit 100 decodes a media signal so as to output the media signal, and includes a media signal input unit 110, a media signal decoding unit 120, a media signal output unit 130. The media signal input unit 110 can receive a media signal IN1 through a wired/wireless communication network, or can extract the media signal stored in an inner storage medium or an outer storage medium. In addition, when the media signal is a broadcasting signal, the media signal input unit 110 can tune a channel frequency received by an antenna, a cable, a satellite or the like, and can demodulate the tuned signal, wherein modulation performed in a transmitter is inversely performed as demodulation, so as to output the demodulated signal as a transport stream corresponding to the media signal. In the present embodiment, the media signal includes an audio signal, a video signal, other data signals or the like. The media signal input unit 110 transmits the media signal, which is received or extracted, to the media signal decoding unit 120. The media signal decoding unit 120 extracts audio/video/addition data streams from the demodulated transport stream, and respectively decodes the extracted audio/video/addition data streams using decoding algorithms to restore an original signal. The media signal output unit 130 outputs a signal OUT1 restored by the media signal decoding unit 120 so as to reproduce the signal using a screen, from a speaker or the like.

The media signal reproduction controlling unit 200 controls the media signal to reproduce the media signal, and includes a user interface 210, a controlling unit 220, an on screen display (OSD) processing unit 230 and a tag information processing unit 203. The user interface 210 functions as an interface to allow the user to give a user command IN2 to the controlling unit 220. The user command IN2 may include a command or data input by a user. The user can request tag information for controlling reproduction of the media signal to be generated using the user interface 210. In addition, after the tag information is generated, the user can select the tag information to be used when reproducing the media signal by using the user interface 210. Then, the media signal can be reproduced according to the selected tag information. The user interface 210 includes a remote controller or a key pad installed in the apparatus to control reproduction of the media signal.

The OSD processing unit 230 generates OSD data OUT2, and outputs the generated OSD data. The OSD processing unit 230 outputs a display signal to a screen, so that the tag information is requested to be input. The user can input information of tag properties, which is requested by the OSD processing unit 230, by using the user interface 210. The controlling unit 220 controls the apparatus to control reproduction of the media signal, generates the tag information, according to the request of the user using the user interface 210, and controls the reproduction of the media signal using the generated tag information.

The tag information processing unit 203 generates the tag information, and stores the generated tag information, or controls the reproduction of the media signal using the generated tag information. In addition, the tag information processing unit 203 includes a tag information generating unit 240, a tag information storage unit 250 and a tag information comparing unit 260.

The tag information generating unit 240 generates the tag information, according to the request of the user.

The user requests the tag information to be generated with respect to a part of the media signal which is currently being reproduced. Then, the tag information generating unit 240 extracts information about a reproducing time of the media signal which is currently being reproduced, sets the reproducing time as a tag time, and stores the information of tag properties input by the user together with the tag time in a tag so as to generate the tag information. In addition, the tag information may include a request for starting control, a request for finishing control and a controlling property. The request for starting control is information indicating that control will be started from a part of the media signal which is currently being reproduced. The request for finishing control is information indicating that control will be finished at a part of the media signal which is currently being reproduced. The controlling property is information indicating how to control a section of the media signal, selected by the user. The controlling property is information indicating a method of controlling reproduction of the media signal, in which speed-regulation, signal-skip, changes in tone of an audio signal or the location of a sound signal, or regulation of color or resolution of a video signal is included. The user can select whether the media signal is to be skipped, whether a reproducing speed is to be reduced or increased, whether the media signal is to be repeatedly reproduced, whether the audio signal is to be converted so as to be reproduced, or the video signal is to be converted so as to be reproduced.

When the tag information generating unit 240 receives the request for starting control or the request for finishing control, which is selected by the user, the tag information generating unit 240 extracts the reproducing time of the media signal in order to set the reproducing time as the tag time, and stores the request for starting control or the request for finishing control, the tag time and the controlling property in the tag so as to generate the tag information, according to the request for starting control or the request for finishing control. The tag information is generated according to an order of requests for generating tag information of the user. The user can first make the request for starting control, and then can make the request for finishing control included in the tag information, which has the same property as the request for starting control. When the controlling properties included in the tag information are not the same, a plurality of requests for starting control can be made.

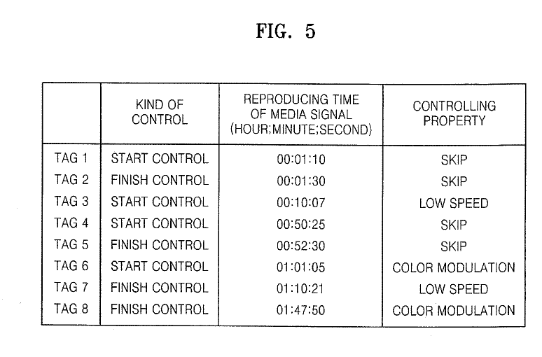

The tag information can be generated as illustrated in FIG. 5. FIG. 5 is a view illustrating the tag information generated from the apparatus of FIG. 1 according to an embodiment of the present general inventive concept. Referring to FIG. 5, the tag information is generated according to an order of reproduction of media signals. As described above, the tag information includes the kind of control, which indicates whether the request for controlling made by the user is the request for starting control or the request for finishing control, the tag time, which indicates a time at which the request for controlling of the media signal is received from the user, and the controlling property. The tag information is generated according to the order of reproducing the media signals. When the controlling properties are the same, after the request for starting control is made, the request for finishing control can be made. When the controlling properties are not the same, tags having different controlling properties can be generated regardless of the request for starting control or the request for finishing control.

The tag information storage unit 250 stores the tag information generated by the tag information generating unit 240. The tag information storage unit 250 can store the generated tag information according to the order of generating tag information or the order of information of tag properties. When the tag information comparing unit 260 receives the request for generating media signal from the user after the tag information is generated, the tag information comparing unit 260 receives the tag information selected by the user, which is to be used for controlling, and extracts the selected tag information from the tag information storage unit 250. When the tag time included in the tag information selected by the user is the same as the reproducing time of the media signal that is currently being reproduced, the tag information comparing unit 260 requests the controlling unit 220 to control according to the request for starting control or the request for finishing control, and the controlling property included in the tag information. The controlling unit 220 controls the media signal decoding unit 120 and the media signal output unit 130 according to the request of the tag information comparing unit 260 so that the media signal may be controlled to be reproduced according to the tag information.

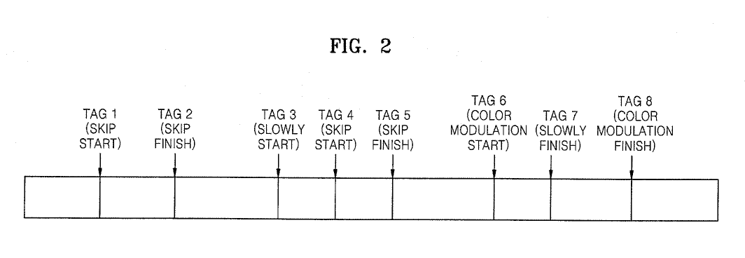

FIG. 2 is a view illustrating a media signal in a time sequence, according to an embodiment of the present general inventive concept. Referring to FIGS. 1 and 2, a horizontal axis is the reproducing time of a media signal. While the media signal which is currently being reproduced is used, if the user wants to skip a predetermined section of a media signal, the user makes the request for starting control at a point when the predetermined section is started. The controlling unit 220 extracts the reproducing time of a media signal, which is currently being reproduced, according to the user's request for starting control to set the reproduce time as the tag time. The controlling unit 220 outputs a display signal to an OSD screen, on which the user requests a controlling property to be input, by using the OSD processing unit 230. The user selects ‘skip’, which is the controlling property desired by the user, on the OSD screen. As described above, the controlling property may include skip, speed-regulation, color-regulation, repeat-reproduction or the like. The tag information generating unit 240 stores the request for starting control, the tag time and the information of tag properties on a tag so as to generate the tag information. When the tag generated at this time is denoted by a tag 1, the tag 1 is generated at a point when the user makes the request for starting control, as illustrated in FIG. 2. Although the tag 1 is indicated in the media signal for convenience of explanation in FIG. 2, the tag information can be stored in the tag information storage unit 250 independently from the media signal. Here, the starting control and finishing control may be a control command to perform reproducing of the media signal and to stop reproducing of the media signal according to the starting time and the finishing time, respectively.

The user makes the request for finishing control at a point when the predetermined section, which is desired to be skipped by the user, is finished, and selects ‘skip’ as the controlling property. The controlling unit 220 extracts the reproducing time of the media signal which is currently being reproduced, so as to set the reproducing time as the tag time, according to the request for finishing control. The tag information generating unit 240 stores the request for finishing control, the tag time, at which control is finished, and the information of tag properties on the tag so as to generate the tag information. When the tag, in which the tag information is generated at this time, is denoted by a tag 2, the tag 2 is generated at a point when the user commands the request for finishing control.

Using the same method, the user makes the request for starting control and the request for finishing control at points when sections, where the reproducing speeds of media signal are desired to be reduced by the user, start and finish, and can select ‘low speed’ as the controlling property. The tag information generating unit 240 stores the request for starting control, the reproducing time of the media signal, when control is started, and the ‘low speed’, which is the information of a tag property, in the tag to generate a tag 3. When a section of the media signal, which is desired to be skipped by the user, is included in a section where the reproducing speed of media signal is desired to be reduced, the user can again make the request for starting control and the request for finishing control using the user interface 210, and can select ‘skip’ as the controlling property. The tag information generating unit 240 stores the request for starting control, the reproducing time of the media signal, when the media signal is desired to be skipped, and ‘skip’, which is the information of tag properties, in the tag so as to generate a tag 4.

In addition, the tag information generating unit 240 stores the request for finishing control, the reproducing time of the media signal, when the skip of the media signal is desired to be finished, and the information of tag properties in the tag so as to generate a tag 5. Likewise, when there is a point of time, when a color is desired to be modulated in order to be reproduced, before the section where the reproducing speed of the media signal is to be reduced is finished, the user selects the request for starting control and the controlling property so as to request the tag information to be generated.

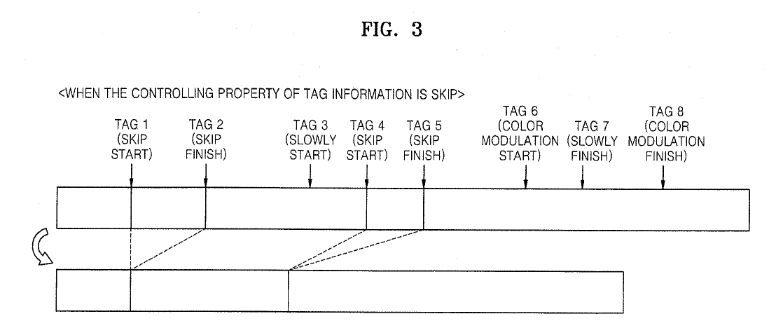

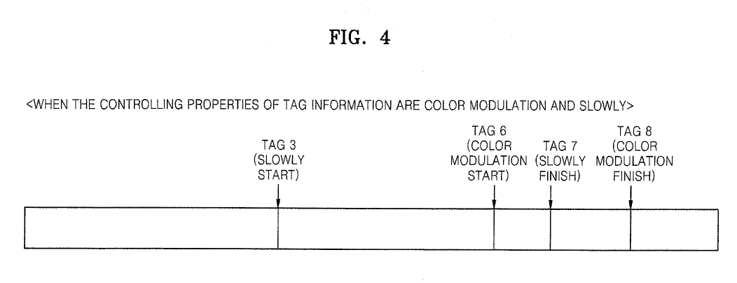

FIGS. 3 and 4 are views illustrating a media signal reproduced when the media signal is controlled to be reproduced by using the tag information according to embodiments of the present general inventive concept. The tag information may be generated as illustrated in FIG. 2. After the tag information is generated, the user selects the tag, which is used when the reproducing of media signal is controlled, from a plurality of stored tags. The user can select the desired tag using the tag information included in the tag. For example, the user can select the tag using the controlling property.

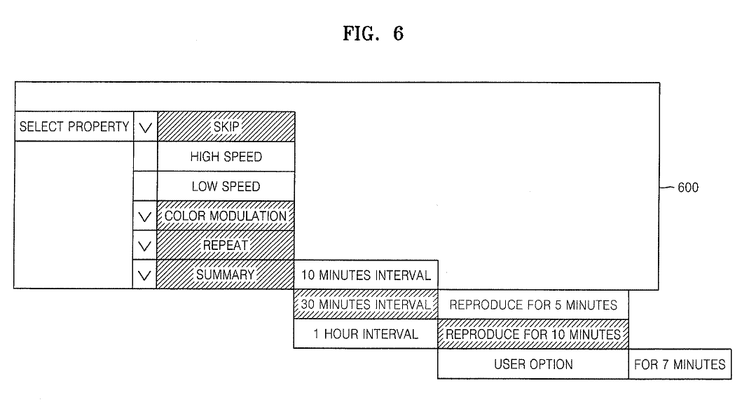

FIG. 6 is a view illustrating an OSD output screen 600, according to an embodiment of the present general inventive concept. Referring to FIG. 6, the user can select the desired tag on the OSD output screen 600, signals for which are output by the OSD processing unit 230. The user can select the tag, which is to be used when the media signal is reproduced, on the OSD output screen 600. The user can select the desired controlling property on the OSD output screen 600 so as to select the tag. When the controlling property is ‘repeated reproduction’, the user can select the number of times reproduction is to be repeated, among a list of numbers, or can input the number of times reproduction is to be repeated. When the controlling property is ‘summary reproduction’, that is, when the media signal is desired to be reproduced at a predetermined interval and for a predetermined time, the user can select intervals at which the media signal is reproduced, and a period in which the media is reproduced, and can personally input the interval or the period.

Referring to FIGS. 1 through 6, when the user desires the reproduction of the media signal to be controlled using the tag, of which the tag property from the tag information generated in FIG. 2 is ‘skip’, the controlling unit 220 controls the tag information storage unit 250 so as to extract the tag of which the tag property is ‘skip’, which is stored in the tag information storage unit 250, so as to send the tag to the tag information comparing unit 260. The tag information storage unit 250 extracts the tag information of tags of which information of the tag property is ‘skip’ (i.e., tag 1, tag 2, tag 4 and tag 5) according to the command of the controlling unit 220 so as to transmit the tags to the tag information comparing unit 260. The controlling unit 220 controls the media signal decoding unit 120, and transmits a current reproducing time of the media signal to the tag information comparing unit 260. The media signal decoding unit 120 transmits the reproducing time of the media signal which is currently being reproduced to the tag information comparing unit 260, according to the command of the controlling unit 220. The tag information comparing unit 260 compares the tag time of the tag information, of which the tag property received from the tag information storage unit 250 is ‘skip’, with the reproducing time of the media signal which is currently being reproduced, in real time. When the reproducing time of the media signal which is currently being reproduced is the same as the tag time included in the tag information, the tag information comparing unit 260 notifies the controlling unit 220 of the fact.

When the reproducing time of the media signal is the same as the tag time, the controlling unit 220 controls the media signal decoding unit 120 so that the media signal may be reproduced according to the tag information. That is, when the time of the media signal is the same as the tag time of the tag 1, the controlling unit 220 skips reproduction of the media signal until a point of time at which the controlling unit 220 receives the request for finishing control of ‘skip’ of the tag 2. In addition, when the reproducing time of the media signal is the same as the tag time of the tag 4, the controlling unit 220 skips the reproduction of the media signal until the tag time of the tag 5. FIG. 3 is a view illustrating when the media signal is controlled to be reproduced using tag information generated as described in relation to FIG. 2, according to an embodiment of the present invention.

Similarly to FIG. 3, when the user requests the media signal to be reproduced using the tag of which tag properties are ‘color modulation’ and ‘low speed’, the tag information storage unit 250 extracts the tags 6 and 8, of which the tag property is ‘color modulation’, and the tags 3 and 7, of which the tag property is ‘low speed’, from the tag information of FIG. 2 according to the command of the controlling unit 220, and transmits the tag information of the extracted tag 6 and 8 and 3 and 7 to the tag information comparing unit 260. In addition, the media signal decoding unit 120 transmits the reproducing time of the media signal which is currently being reproduced, to the tag information comparing unit 260, according to the command of the controlling unit 220. The tag information comparing unit 260 compares the tag time of the tags 3, 6, 7 and 8 with the reproducing time of the media signal. Then, when the tag time is the same as the reproducing time of the media signal, the tag information comparing unit 260 notifies the controlling unit 220 that the tag time is the same as the reproducing time of the media signal. When the tag time is the same as the current reproducing time of the media signal, the controlling unit 220 controls the media signal decoding unit 120 according to the tag property included in the tag information so as to control reproduction of the media signal.

In FIG. 4, during reproduction of the media signal, the media signal decoding unit 120 slowly reproduces the media signal according to the tag property of the tag 3 when the reproducing time of the media signal is the same as the tag time of the tag 3. In addition, when the reproducing time of the media signal is the same as the tag time of the tag 6, the media signal decoding unit 120 continues to slowly reproduce the media signal, and simultaneously, converts the color of the media signal to reproduce the media signal. When the reproducing time of the media signal is the same as the tag time of the tag 7, the media signal decoding unit 120 continues to convert the color of the media signal so as to reproduce the media signal while simultaneously reproducing the media signal at an original speed. When the reproducing time of the media signal is the same as the tag time of the tag 8, the media signal decoding unit 120 reproduces the media signal to have an original color.

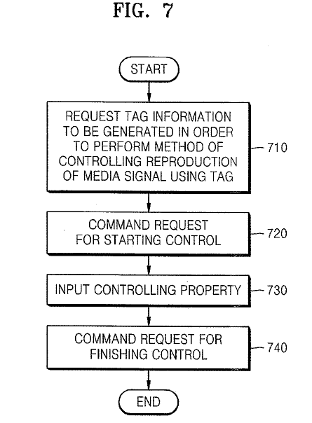

FIG. 7 is a flow chart illustrating a method, in which tag information is input by a user in order to perform a method of controlling reproduction of a media signal, according to an embodiment of the present general inventive concept.

Referring to FIG. 7, the user requests the tag information to be generated in order to perform the method of controlling reproduction of a media signal by using a tag (operation 710). The user makes a request for starting control at a point at which the user desires the media which is currently being reproduced to be controlled (operation 720). The controlling unit 220 generates a screen, on which a controlling property is requested to be input, using the OSD processing unit 230 or the like and outputs the generated screen. The user inputs the controlling property corresponding to the screen (operation 730). When the controlling property is ‘repeat-reproduction’, ‘summary’ or the like, in which a number is required to be input, the user can select one of a list of numbers or can directly input the number by using the OSD processing unit 230 or the like to correspond to the controlling property. The user continues to use the media signal which is currently being reproduced and then makes a request for finishing control at a point at which control is desired to be finished (operation 740). The tag information generating unit 240 extracts the reproducing time of media signal of the point at which the requests for control are made and sets the extracted reproducing time as a tag time. A tag information generating unit 240 stores the tag time, the controlling property and control-starting/finishing in the tag in order to generate the tag information.

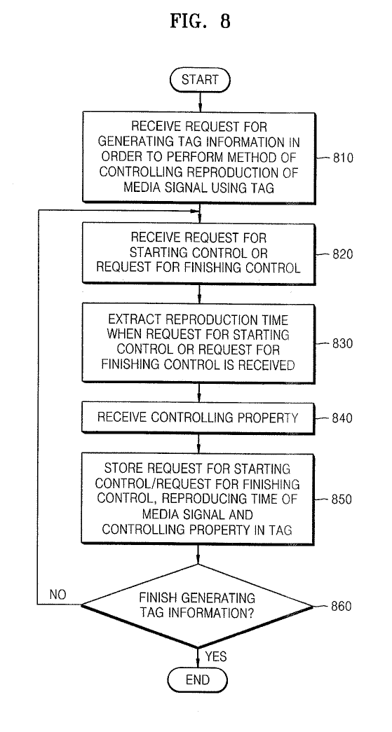

FIG. 8 is a flow chart illustrating a method of generating tag information, which is performed in an apparatus to control reproduction of a media signal, according to an embodiment of the present general inventive concept. Referring to FIG. 8, the apparatus to control reproduction of a media signal receives a request for generating tag information from a user in order to perform a method of controlling reproduction of a media signal (operation 810). The apparatus to control reproduction of a media signal receives a request for starting control or a request for finishing control from the user during reproduction of the media signal (operation 820). The apparatus to control reproduction of a media signal extracts the reproducing time of media signal which is currently being reproduced, according to the request for starting control or the request for finishing control of the user, and sets the extracted reproduction time of the media signal as a tag time (operation 830). The apparatus to control reproduction of a media signal receives a controlling property with respect to the request for starting control or the request for finishing control from the user (operation 840). The apparatus to control reproduction of a media signal stores one of the request for starting control and the request for finishing control, and the controlling property, which is input by the user, together with the tag time in a tag (operation 850). The apparatus to control reproduction of a media signal continues to generate the tag information until the apparatus to control reproduction of a media signal receives the request for finishing tag information generation from the user with respect to the media signal which is currently being reproduced, or until the media signal which is currently being reproduced, is finished.

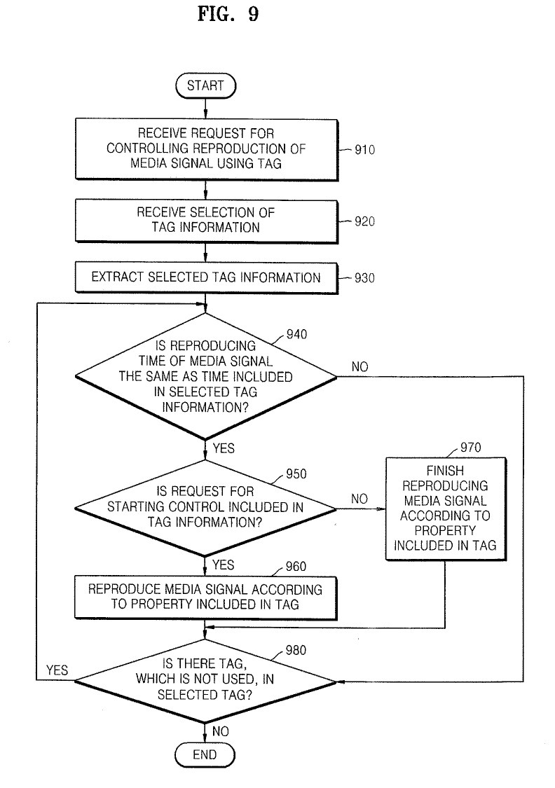

FIG. 9 is a flow chart illustrating a method of control reproduction of a media signal using tag, which is performed in an apparatus to control reproduction of a media signal, according to an embodiment of the present general inventive concept. Referring to FIG. 9, the apparatus to control reproduction of a media signal generates the tag information in order to store the tag information. The apparatus to control reproduction of a media signal receives a request for controlling reproduction of a media signal from the user using a tag (operation 910).

The apparatus to control reproduction of a media signal outputs the stored tag information to the user, by using the OSD processing unit 230, and receives a selection of the tag information from the user (operation 920). The user can select the tag information using the controlling property or the like. The apparatus to control reproduction of a media signal extracts the tag information selected by the user (operation 930), and compares the extracted tag information with the reproducing time of the media signal which is currently being reproduced. The apparatus to control reproduction of a media signal determines whether the reproducing time of media signal is the same as the tag time included in the tag selected by the user (operation 940). When the reproducing time of media signal is the same as a control time, the apparatus to control reproduction of a media signal determines whether a request for control included in the tag information is a request for starting control (operation 950). When the request for control included in the tag information is the request for staring control, the apparatus to control reproduction of a media signal reproduces the media signal according to a tag property included in the tag (operation 960). When the request for control included in the tag information is not the request for starting control, that is, when the request for control is a request for finishing control, the apparatus to control reproduction of a media signal finishes generating the media signal according to the tag property included in the tag (operation 970). The apparatus to control reproduction of a media signal determines whether the selected tag is a tag that is not used (operation 980), and the apparatus to control reproduction of a media signal repeatedly performs the above method when there is a tag that is not used.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to the method and apparatus to control reproduction of a media signal by using a tag, the media signal can be reproduced without requiring a conventional encoding process.

According to the method and apparatus to control reproduction of a media signal by using a tag, tag information generated independently from an original media signal is used in controlling the media signal, and thus the reproduction of the media signal can be controlled without editing the media signal.

According to the method and apparatus to control reproduction of a media signal by using a tag, tag information is generated so as to be stored in order to control the media signal, and thus a memory space to control the reproduction of the media signal is small, and the same method of controlling a media signal can be repeatedly used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling reproduction of a media signal using a tag, the method comprising:
receiving a request for generating tag information to control reproduction of a media signal;
generating the tag information according to the request for generating tag information; and
storing the generated tag information in a tag corresponding to the media signal.

2. The method of claim 1, wherein the receiving of the request for generating tag information comprises receiving one of a request for starting control and a request for finishing control, and a controlling property according to a user preference.

3. The method of claim 2, wherein:
the generating of the tag information comprises:
according to the request for starting control or the request for finishing control, extracting a reproducing time of the media signal of a point at which the request for starting control or the request for finishing control is received, and
generating an identifier indicating one of the request for starting control and the request for finishing control; and
the storing of the generated tag information comprises:
storing the identifier indicating one of the request for starting control and the request for finishing control, and the extracted reproducing time of the media signal and the controlling property in the tag.

4. The method of claim 3, wherein the generating of the tag information comprises:
generating the tag information for each respective reproducing time of the media signal, according to an order of the request for generating tag information.

5. The method of claim 3, wherein the receiving of the requesting for generating the tag information comprises:
receiving the request for finishing control included in the tag information of which a tag property is the same as a tag property of tag information included in the request for starting control, after receiving the request for starting control.

6. A method of controlling reproduction of a media signal, the method comprising:
receiving a selection of tag information that is to be used to control reproduction of the media signal; and
controlling the reproduction of the media signal by using the selected tag information,
wherein the controlling of the reproduction comprises:
extracting the tag information that is stored independently from the media signal so as to reproduce the media signal according to the tag information.

7. The method of claim 6, wherein:
the tag information comprises:
an identifier indicating one of a request for starting control and a request for finishing control, and a reproducing time of reproduction of the media signal of a point, at which the request for starting control or the request for finishing control is received, according to the request for starting control or the request for finishing control, and a controlling property; and
the controlling of the reproduction of the media signal comprises:
when a reproducing time of the media signal which is currently being reproduced is the same as the reproducing time of the media signal which is stored according to the request for starting control, reproducing the media signal according to the controlling property included in the tag, and
when the reproducing time of the media signal is the same as the reproducing time of the media signal which is stored according to the request for finishing control, finishing the reproduction of the media signal according to the controlling property included in the tag.

8. The method of claim 7, wherein:
the receiving of the selection of tag information is performed by using the controlling property included in the tag information; and
the controlling of the reproducing of the media signal comprises:
extracting all tags including the selected controlling property; and
controlling the reproduction of the media signal according to the controlling property, using an identifier indicating one of the request for starting control and the request for finishing control, and a reproducing time of the media signal, which is stored according to the request for starting control and the request for finishing control, which are include in the extracted tag.

9. The method of claim 8, wherein the number of pieces of the tag information including the same controlling property is two or more.

10. The method of claim 8, wherein:
the receiving of the selection of the tag information comprises:
receiving a selection of a plurality of controlling properties; and
the extracting of the all tags including the selected controlling property comprises:
extracting all tags including the selected controlling properties.

11. An apparatus to control reproduction of a media signal using a tag, the apparatus comprising:
a decoding unit to decode an input media signal;
a media signal output unit to output the decoded media signal;
a tag information processing unit to generate tag information to control the reproduction of the media signal, and to store the generated tag information;
a user interface; and
a controlling unit to control reproduction of the media signal, to generate the tag information according to a request of a user using the user interface, and to store the generated tag information.

12. The apparatus of claim 11, wherein the tag information processing unit comprises:
a tag information generating unit to generate the tag information according to the request of the user; and
a tag information storage unit to store the generated tag information.

13. The apparatus of claim 11, further comprising:
an on screen display (OSD) processing unit to generate OSD data including a list for generating tag information and to output the OSD data, in order to receive the request for generating tag information from a user.

14. The apparatus of claim 12, wherein:
the controlling unit receives one of a request for starting control and a request for finishing control, and a controlling property from the user, and transmits one of the request for starting control and the request for finishing control, and the controlling property to the tag information generating unit to request generation of tag information;
according to the request for starting control or the request for finishing control, the tag information generating unit extracts a reproducing time of the media signal when the request for starting control or the request for finishing control is made, and generates an identifier indicating one of the request for starting control and the request for finishing control; and
the tag information storage unit stores the identifier indicating one of the request for starting control and the request for finishing control, the extracted reproducing time of the media signal and the controlling property in the tag.

15. The apparatus of claim 14, wherein the tag information generating unit generates the tag information for each respective reproducing time of the media signal according to an order of request for generating the tag information.

16. The apparatus of claim 14, wherein the controlling unit receives the request for finishing control included in tag information having the same property as the tag information in which the request for starting control is included, after the request for starting control is received from the user.

17. An apparatus to control reproduction of a media signal using a tag, the apparatus comprising:
a decoding unit to decode an input media signal;
a media signal outputting unit to output the decoded media signal;
a tag information processing unit to compare tag information with the media signal in order to control the reproduction of the media signal;
a user interface; and
a controlling unit to control reproduction of the media signal, to receive selection of the tag information, which is to be used in reproduction of the media signal, from a user, and controlling the reproduction of the media signal according to the selected tag information.

18. The apparatus of claim 17, further comprising:
an on screen display (OSD) processing unit to generate OSD data including a list for selecting tag information, and to output the OSD data in order to receive selection of tag information from the user.

19. The apparatus of claim 17, wherein:
the tag information comprises an identifier indicating one of a request for starting control and a request for finishing control, a reproducing time of the media signal when the request for starting control or the request for finishing control is made, and a controlling property;
when a reproducing time of the media signal which is currently being reproduced is the same as the reproducing time of the media signal stored according to the request for starting control, the controlling unit reproduces the media signal according to the controlling property included in the tag; and
when the reproducing time of the media signal is the same as the reproducing time of the media signal stored according to the request for finishing control, the controlling unit finishes the reproduction of the media signal according to the controlling property.

20. The apparatus of claim 19, wherein the controlling unit receives selection of tag information using the controlling property included in the tag information from the user, extracts all tag including the selected controlling property, and controls the reproduction of the media signal according to the controlling property, using the identifier included in the extracted tag, indicating one of the request for starting control and the request for finishing control, the reproducing time of the media signal, included in the extracted tag, which is stored according to the request for starting control or the request for finishing control.

21. The apparatus of claim 20, wherein the tag information comprises at least two pieces of tag information including the same controlling property.

22. The apparatus of claim 20, wherein when selection of a plurality of controlling properties is received from the user, the controlling unit extracts all tags including the controlling properties.

23. An apparatus to control reproduction of a media signal using a tag, the apparatus comprising:
a media signal reproducing unit to decode a media signal and to output the decoded media signal; and
a media signal reproduction controlling unit to receive a request for generating tag information to control reproduction of a media signal, to generate the tag information according to the request for generating tag information, and to store the generated tag information in a tag corresponding to the media signals.

24. An apparatus to control reproduction of a media signal using a tag, the apparatus comprising:
a media signal reproducing unit to decode a media signal and to output the decoded media signal; and
a media signal reproduction controlling unit to receive a selection of the tag information that is to be used to control reproduction of the media signal, to control the reproduction of the media signal by using the selected tag information by extracting the tag information that is stored independently from the media signal so as to reproduce the media signal according to the tag information.

25. An apparatus to control reproduction of a media signal using a tag, the apparatus comprising:
a media signal reproducing unit to decode a media signal and to output the decoded media signal; and
a media signal reproduction controlling unit to receive a request for generating tag information to control reproduction of a media signal, to generate the tag information according to the request for generating tag information, to store the generated tag information in a tag corresponding to the media signals, to receive a selection of the tag information that is to be used to control reproduction of the media signal, to control the reproduction of the media signal by using the selected tag information by extracting the tag information that is stored independently from the media signal so as to generate the media signal according to the tag information.

26. A method of controlling reproduction of a media signal using a tag, the method comprising:
receiving a request for generating tag information to control reproduction of a media signal, generating the tag information according to the request for generating tag information, and storing the generated tag information in a tag corresponding to the media signal; and
receiving a selection of tag information that is to be used to control reproduction of the media signal, and controlling the reproduction of the media signal by using the selected tag information by extracting the tag information that is stored independently from the media signal so as to reproduce the media signal according to the tag information.

27. An apparatus to control reproduction of a media signal using a tag, the apparatus comprising:
a media signal reproducing unit to decode a media signal and output the decode media signal; and
a media signal reproduction controlling unit to independently process tag information from the media signal reproducing unit, and to control the media signal reproducing unit to decode and output the media signal according to the tag information.

28. The apparatus of claim 27, wherein the media signal reproducing unit receives an input signal and decodes the input signal as the media signal, and does not encode or edit the input signal according to the tag information

29. The apparatus of claim 27, wherein:
the tag information comprises a reproducing time and a reproducing property corresponding to the reproducing time;
the media signal reproducing unit generates a current reproducing time and a current reproducing property of the media signal; and
the media signal reproduction controlling unit controls the media signal reproducing unit to decode and output the media signal according to the reproducing time and the reproducing property of the tag information and the current reproducing time and the current reproducing property of the media signal.
